(19) United States
(12) Patent Application Publication
(10) Pub. No.: US 2007/0075956 A1
(43) Pub. Date: Apr. 5, 2007

(54) Mobile terminal apparatus

(75) Inventors: Ichirou Satou, Tokyo (JP); Atsushi Katagiri, Kanagawa (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 10/576,550

(22) PCT Filed: Nov. 4, 2004
(86) PCT No.: PCT/JP04/16323

§ 371 Date: Apr. 19, 2006

(51) Int. Cl. G09G 3/36

(52) U.S. Cl. 345/98

(57) ABSTRACT

The present invention is to provide mobile terminal apparatus capable of suppressing occurrence of noise while keeping required display capacity in accordance with the operation condition of the apparatus.

A control portion 16 and a display portion controller 19 control driving of a display portion 20 comprised of a liquid crystal display unit, and change the driving operation such as a drive system, a driving frequency, etc. into a suitable driving condition in accordance with the operation condition of the apparatus. For example, driving operation giving priority to the image quality of an image displayed on the display portion 20 is performed using sequential scanning drive such as one-line inversion drive when a movie is displayed in a camera operation mode or the like. Thus, visibility is improved. In another operation mode such as a voice call mode, driving operation giving priority to the acoustic characteristic is performed using interlaced scanning drive such as interlace drive so as to suppress noise caused by the display portion 20. Thus, a good use environment is secured.

### TECHNICAL FIELD

The present invention relates to mobile terminal apparatus having a display unit such as a liquid crystal display unit or the like.

### BACKGROUND ART

In recent years, liquid crystal display units have been often used as display units in mobile terminal apparatus such as mobile information terminals, cellular phones, small-size information equipments, etc. Users obtain necessary information from contents displayed on these display units. As for such a display unit used in mobile terminal apparatus, it is requested to make a display panel thinner to meet the demand of reduction in size and weight.

FIG. 12 is a longitudinal sectional view showing an example of the configuration of a display portion of a related-art liquid crystal display unit applied to mobile terminal apparatus. In the liquid crystal display unit, a liquid crystal display panel 5 is disposed correspondingly to a display window 514 opened in a housing 511 forming a body of the mobile terminal apparatus, and an acrylic panel 512 is attached to the display window 514. In addition, spacers 515 are disposed between the acrylic panel 512 and the liquid crystal display panel 5 so as to form an air layer 513.

As shown in FIG. 12, the liquid crystal display unit for the mobile terminal apparatus is usually designed so that the acrylic panel 512 is not disposed directly on the surface of the liquid crystal display panel 5. This is because there occur problems in such a layout as follows. That is, external impact may be applied directly to the light crystal display panel 5, or optical interference fringes may occur to depress visibility of display on the liquid crystal display panel 5. Accordingly, from the nature of the liquid crystal display unit for the mobile terminal apparatus, the air layer 513 for retaining a space is required between the acrylic panel 512 and the liquid crystal display panel 5.

The liquid crystal display panel 5 has a laminated structure as follows. That is, a glass substrate 501 and a glass substrate 505 are disposed at an interval with crystal spacers 516 put therebetween. A liquid crystal is injected into a space defined by a seal member for sealing this interval portion so as to form a liquid crystal layer 503. Further, polarizing plates 506 are disposed on the sides of the glass substrates 501 and 505 opposite to the liquid crystal layer 3 side respectively.

In addition, a backlight module 508 is disposed under the liquid crystal display panel 5. This backlight module 508 is covered with a frame 509 for the backlight. The frame 509 is fixed to the housing 511 by screws 510.

A pattern of a transparent electrode 502 is formed in the liquid crystal layer 503 side surface of the glass substrate 501. A semiconductor chip serving as a driver IC outputting an electric signal for driving the liquid crystal layer 503 is mounted on this pattern of the transparent electrode 502 so as to be electrically connected thereto.

A pattern of transparent electrodes 504 corresponding to display pixels of the liquid crystal respectively is formed on the liquid crystal layer 503 side surface of the glass substrate 505. In the same manner as in the transparent electrode 502, a semiconductor chip serving as a driver IC outputting an electric signal for driving the liquid crystal layer 503 is mounted on this pattern of the transparent electrodes 504 so as to be electrically connected thereto.

In the liquid crystal display panel 5 configured thus, the semiconductor chips output image forming signals in accordance with an operation signal from an operation portion or the like. Based on these image forming signals, the liquid crystal layer 503 can be driven to display characters or graphics.

There are a plurality of systems for driving the liquid crystal display unit configured thus. Of them, a drive system called a one-line inversion drive system in which there are not many problems as to various kinds of problems involving a failure in display (unevenness, crosstalk, etc.) has been mainly used.

Incidentally, as examples of techniques for changing over a display mode of the liquid crystal display unit in order to save the power consumption, there are a technique in which the display mode is changed over from a movie mode to a still-picture mode, for example, when a power supply supervisory portion concludes that the voltage of a battery has dropped (see Patent Document 1), a technique in which the power consumption efficiency is improved by optimizing the number of voltage-applied frames of a non-display portion in a partial display mode in an active matrix type liquid crystal display unit (see Patent Document 2), and so on.

Generally in the liquid crystal display panel, it is necessary to apply a driving voltage to electrodes having a liquid crystal layer put therebetween. However, the driving voltage in the aforementioned one-line inversion drive system is so high that the frequency of signal waveform applied to the electrodes reaches an audio-frequency (40Hz to 20 kHz) band that can be perceived by human ears. Therefore, this frequency may be heard as noise (sounding) for human beings in the liquid crystal display panel engaging in display operation by the one-line inversion drive system. Further, even in another system than the one-line inversion drive system, there occurs noise in the same manner as described above, when a drive system in which the frequency of signal waveform applied to electrodes becomes an audio frequency is used.

In the display portion of the mobile terminal apparatus configured as shown in FIG. 12, the acrylic panel 512 is electrostatically charged when the acrylic panel 512 is rubbed with a human finger in order to remove stains deposited on the acrylic panel 512 or when the acrylic panel 512 is pressed by a human finger so that the acrylic panel 512 and the polarizing plate 506 are brought into contact.

When the acrylic panel 512 is charged with static electricity etc., the two configurations of the charged acrylic panel 512 and the transparent electrode 502 form an electrostatic loudspeaker structure in the liquid crystal display unit configured as shown in FIG. 12. Description will be made below about an electrostatic loudspeaker.

FIG. 13 is a configuration diagram of an electrostatic loudspeaker. As shown in FIG. 13, the electrostatic loudspeaker has a configuration as follows. That is, a diaphragm electrode 601 and a counter electrode 602 on the back surface side thereof are provided. When a high DC voltage (bias voltage E0 for the counter electrode 602) and an AC voltage (AC voltage E to be applied to the diaphragm electrode 601) superimposed on each other are applied between the both electrodes, an electrostatic attraction force corresponding to the voltages is generated so that the diaphragm electrode 601 oscillates. The oscillation is output as sound.

In the liquid crystal display unit as shown in FIG. 12, the acrylic panel 512 charged with static electricity corresponds to the diaphragm electrode 601 in FIG. 13 (the voltage E in FIG. 13 corresponds to the static electricity), while the transparent electrode 502 corresponds to the counter electrode 602 in FIG. 13. Thus, the acrylic panel 512 and the transparent electrode 502 form an electrostatic loudspeaker.

Accordingly, in the liquid crystal display unit in the related art, a sound whose frequency corresponds to the frequency of the signal waveform of the voltage applied to the transparent electrode 502 is generated by the electrostatic loudspeaker structure formed due to charging of the acrylic panel 512 as described above. Thus, there has been a problem that there occurs a noise much louder than when the acrylic panel 512 is not charged. The aforementioned noise has great influence particularly when the frequency of the aforementioned generated sound is a frequency in a range of from 400 Hz to 13 kHz to which human beings are sensitive.

A force F oscillating the diaphragm electrode 601 of the electrostatic loudspeaker shown in FIG. 13 is obtained by a theory of electrostatics as the following Expression 1.
F=ε₀S/2×(E₀+E)²/g₀² [Expression 1]

Here, ε₀ designates permittivity of vacuum, and g₀ designates a distance between the diaphragm electrode 601 and the counter electrode 602.

As is apparent from Expression 1, the force F oscillating the diaphragm electrode 601 increases in inverse proportion to the square of the distance between the diaphragm electrode 601 and the counter electrode 602. The sound pressure level of the noise also increases in proportion to this force F.

As described previously, it is an essential problem to reduce the thickness of mobile terminal apparatus such as a cellular phone or the like. It is therefore preferable that the distance between the acrylic panel 512 and the liquid crystal display panel 5 is smaller. However, as the distance between the acrylic panel 512 and the liquid crystal display panel 5 is reduced, the acrylic panel 512 is brought closer to the transparent electrode 502 so as to increase the force F oscillating the acrylic panel 512. As a result, the aforementioned noise becomes a considerable problem. Therefore, occurrence of the aforementioned noise has been a grave problem in a liquid crystal display unit mounted on mobile terminal apparatus such as a cellular phone or the like, particularly in a liquid crystal display unit designed so that the liquid crystal display unit portion becomes thin. The aforementioned noise has a volume large enough to be audible with a user's ear brought close thereto or at a very calm place. The noise is an important problem particularly in a cellular phone or the like having a structure in which a display portion comes close to a user's ear when the cellular phone is in use.

The problem of sounding which has been described above can be solved by setting the frequency of a driving voltage of the liquid crystal display unit to be a low frequency (e.g. 400 Hz or lower) or a high frequency (e.g. 20 kHz or higher) so that the sound pressure level generated by the electrostatic loudspeaker structure is prevented from falling into a human audible range.

As driving methods for substantially reducing the driving frequency of the liquid crystal display unit, frame inversion drive and interlace drive are available. In the frame inversion drive, the driving frequency is about 60-100 Hz. Accordingly, the power consumption can be reduced by largely lowering the driving frequency. Thus, the frame inversion drive is very excellent in terms of sounding. However, the frame inversion drive generally has a problem in image quality. That is, unevenness in the up/down direction of a display screen, crosstalk with which a black portion on the display screen looks blurred vertically, flicker with which the display screen flickers, etc. are easy to come to the fore particularly in a transmission type liquid crystal. On the other hand, in the interlace drive, the driving frequency is about 120-400 Hz. Accordingly, the driving frequency can be lowered. Further, when a still picture is displayed, unevenness in the up/down direction of the display screen, crosstalk, flicker, etc. do not matter as compared with those in the frame inversion drive. However, in the interlace drive, there are problems in image quality as follows. That is, when a movie is being displayed, horizontal stripes appear on the display screen, or a user viewing the display screen has a feeling of wrongness.
Patent Document 1: Japanese Patent Laid-Open No. 2002-223291
Patent Document 2: Japanese Patent Laid-Open No. 2002-123222

### DISCLOSURE OF THE INVENTION

### Problems that the Invention is to Solve

The present invention was developed in consideration of the aforementioned circumferences. It is an object of the present invention to provide mobile terminal apparatus which can suppress occurrence of noise while keeping necessary display capacity in accordance with the operation condition of the apparatus.

### Means for Solving the Problems

Mobile terminal apparatus according to the present invention is mobile terminal apparatus with a display portion to be driven by a voltage applied thereto, including display portion driving control means for changing driving operation of the aforementioned display portion including at least one of a drive system and a driving frequency thereof, so as to make driving condition of the display portion adapted to the operation condition of the apparatus itself.

With this configuration, occurrence of noise caused by the display portion or the like can be suppressed while keeping required display capacity in accordance with the operation condition of the apparatus. For example, the drive system or the driving frequency is changed in accordance with each operation condition based on the existence of a movie to be displayed on the display portion, the existence of camera operation, the existence of communication operation, etc. Consequently, suitable image quality can be obtained in the display portion in accordance with the use condition or use purpose of the apparatus, the contents to be displayed, etc., while the apparatus can be used with proper power consumption corresponding to its operation condition. In addition, occurrence of noise can be suppressed in accordance with the operation condition so that a good use environment can be obtained.

As an embodiment of the present invention, in the aforementioned mobile terminal apparatus, the aforementioned display portion driving control means may change the drive system so as to drive the aforementioned display portion by sequential scanning drive when movie display is performed, and to drive the aforementioned display portion by interlaced scanning drive when another display is performed.

With this configuration, the display portion is driven by sequential scanning drive such as one-line inversion drive or the like in order to perform movie display, while the display portion is driven by interlaced scanning drive such as interlace drive or the like in order to perform another display of a still picture or the like. It is therefore possible to obtain mobile terminal apparatus which can perform high-quality display without display noise such as unevenness in the up/down direction of the display screen, crosstalk, flicker, etc. at the time of the movie display, while there is no sounding at the time of another display of a still picture or the like.

As an embodiment of the present invention, in the aforementioned mobile terminal apparatus, the aforementioned display portion driving control means may change the drive system so as to drive the aforementioned display portion by sequential scanning drive in a camera mode for operating a camera, and to drive the aforementioned display portion by interlaced scanning drive in another operation mode.

A movie is often displayed on the display portion in the camera mode. Accordingly, with this configuration, it is possible to perform high-quality display without display noise when a movie is displayed. In addition, the problem of sounding can be suppressed in another operation mode such as a voice call mode or the like.

As an embodiment of the present invention, in the aforementioned mobile terminal apparatus, the aforementioned display portion driving control means may change the drive system of the aforementioned display portion into the sequential scanning drive as soon as the aforementioned camera mode is started, and change the drive system of the aforementioned display portion into the interlaced scanning drive as soon as the aforementioned camera mode is terminated and shifted to another operation mode.

With this configuration, the image quality when a movie is displayed in the camera mode can be improved, while the problem of sounding can be suppressed when the apparatus is shifted from the camera mode to another operation mode.

As an embodiment of the present invention, in the aforementioned mobile terminal apparatus, when the aforementioned display portion driving control means changes the aforementioned driving operation, the display portion driving control means may carry out the aforementioned driving operation change in a period after scanning one screen in the aforementioned display portion is completed and before scanning a next screen is started.

With this configuration, when the driving operation such as the drive system or the like is changed, a failure such as image disorder or the like on the display screen of the display portion can be prevented so that the driving operation change can be made difficult to be recognized by the user.

As an embodiment of the present invention, in the aforementioned mobile terminal apparatus, when the aforementioned display portion driving control means changes the aforementioned driving operation, the display portion driving control means may change display contents of the aforementioned display portion in the vicinity of this driving operation change.

With this configuration, when the driving operation such as the drive system or the like is changed, different images are displayed before and after the driving operation change, so that the driving operation change can be made difficult to be recognized by the user.

As an embodiment of the present invention, in the aforementioned mobile terminal apparatus, the aforementioned display portion driving control means may change at least one of the drive system, the driving frequency and the driving voltage of the aforementioned display portion in accordance with the operation condition of the apparatus itself.

With this configuration, it is possible to obtain mobile terminal apparatus which can be used with more suitable image quality and power consumption in accordance with the use condition or use purpose of the apparatus.

As an embodiment of the present invention, in the aforementioned mobile terminal apparatus, the aforementioned display portion driving control means may change the drive system of the aforementioned display portion into interlaced scanning drive or frame inversion drive when the apparatus itself is in a standby state.

With this configuration, the power consumption can be saved in a standby state such as a wait mode or the like, so that the display portion can be driven with proper power consumption.

### Effect of the Invention

According to the present invention, it is possible to obtain an effect that it is possible to provide mobile terminal apparatus capable of suppressing occurrence of noise while keeping required display capacity in accordance with the operation condition of the apparatus.

### BRIEF DESCRIPTION OF THE DRAWINGS

FIG. 1. A block diagram showing the configuration of a main portion of mobile terminal apparatus according to an embodiment of the present invention.

FIG. 2. A flow chart showing the operation of mobile terminal apparatus according to a first embodiment.

FIG. 3. An explanatory diagram of one-line inversion drive.

FIG. 4. An explanatory diagram of three-line interlace drive.

FIG. 5. An explanatory view of displayed images when a movie is displayed.

FIG. 6. A timing chart for explaining the operation of mobile terminal apparatus according to a second embodiment.

FIG. 7. A flow chart showing the operation of mobile terminal apparatus according to a third embodiment.

FIG. 8. A view showing an example (first example) of displayed images to be changed over when the drive of a display portion is changed.

FIG. 9. A view showing an example (second example) of displayed images to be changed over when the drive of the display portion is changed.

FIG. 10. A view showing operation modes of the mobile terminal apparatus according to this embodiment.

FIG. 11. A diagram showing the correspondence of the contents of driving operation of a display portion to the operation condition of each part in each operation mode in a fourth embodiment.

FIG. 12. A longitudinal sectional view showing an example of the configuration of a display portion of a related-art liquid crystal display unit applied to mobile terminal apparatus.

FIG. 13. A configuration diagram of an electrostatic loudspeaker.

### DESCRIPTION OF REFERENCE NUMERALS

11 call portion
12 transmission/reception portion
13 receiver
14 microphone
16 control portion
17 storage portion
18 operation portion
19 display portion controller
20 display portion
21 camera

### BEST MODE FOR CARRYING OUT THE INVENTION

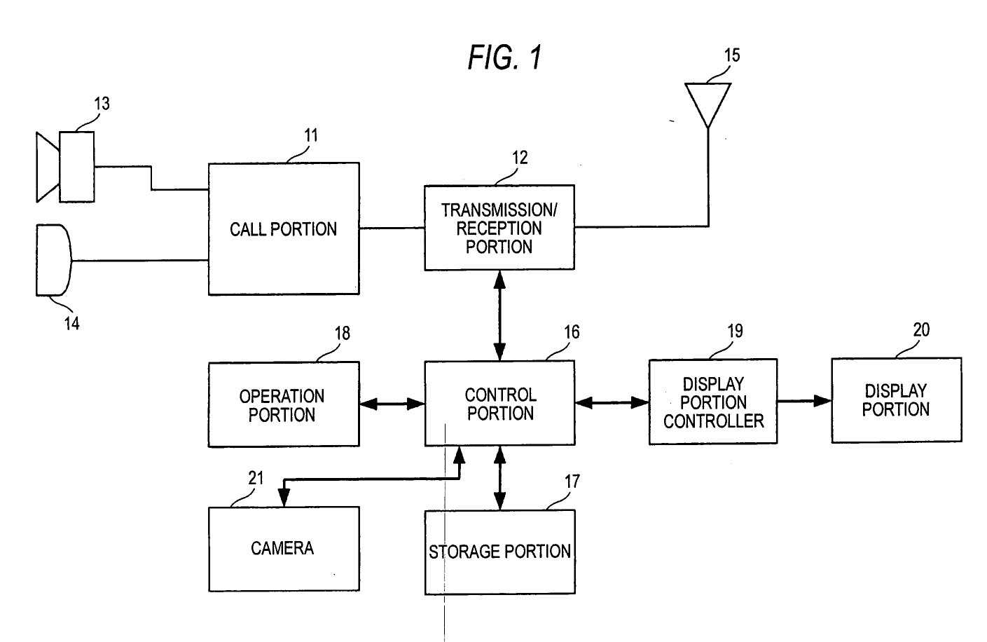

FIG. 1 is a block diagram showing the configuration of a main portion of mobile terminal apparatus according to an embodiment of the present invention. In this embodiment, description will be made using a cellular phone, which is a mobile station terminal of a mobile communication system, as an example of mobile terminal apparatus.

The mobile terminal apparatus according to this embodiment has a call portion 11 for performing conversion or the like on an audio signal for making a voice call, and a transmission/reception portion 12 for performing modulation of a transmission signal for carrying out wireless communication, demodulation of a reception signal, etc. This call portion 11 and this transmission/reception portion 12 serve as voice call means. A receiver 13 for outputting a received speech and a microphone 14 for inputting a speech to be sent are connected to the call portion 11. An antenna 15 for transmitting/receiving communication radio waves is connected to the transmission/reception portion 12. In addition, the mobile terminal apparatus is provided with a control portion 16 for controlling each part, a storage portion 17 for storing various kinds of setting data, telephone directory data, etc., an operation portion 18 having key buttons etc. for performing various operation inputs, a display portion 20 constituted by a liquid crystal display unit for displaying the operation condition of the apparatus and so on, and a display portion controller 19 for driving the display portion 20. Further, the mobile terminal apparatus is provided with a camera 21 for photographing an object and outputting an image signal of a still picture or a movie. The display portion 20 corresponds to an example of display means. The control portion 16 and the display portion controller 19 implement the function of display portion driving control means. Data transfer is performed between the control portion 16 and each of the transmission/reception portion 12, the storage portion 17, the operation portion 18, the display portion controller 19 and the camera 21.

When a voice call is made in this mobile terminal apparatus, the call portion 11 converts an audio signal input from the microphone 14 into a transmission signal while converting a reception signal into an audio signal and outputting the audio signal to the receiver 13. In addition, the transmission/reception portion 12 performs modulation of the transmission signal and demodulation of the reception signal under the control of the control portion 16, and performs transmission and reception of the transmission signal and the reception signal to be exchanged with a base station through the antenna 15.

In this event, number input, instruction input, off-hook, on-hook, etc. are carried out by input based on key operation using the operation portion 18, so as to perform input of a telephone number of a destination, retrieval of a telephone directory, designation of a destination of communication, operation of an outgoing call, operation of response to an incoming call, operation of termination of a call, etc. In addition, the display portion 20 is driven by the display portion controller 19 so as to display information such as a telephone number of a destination of communication, condition of reception, time, etc. on the display portion 20. Further, data including various setting data, telephone directory data such as information about destinations of communication etc., data of electronic mails transmitted or received, image data of still pictures or movies, incoming call sound data, voice data such as voice messages etc., and so on, are written/read into/from the storage portion 17.

For photographing, the camera 21 is activated to capture a still image or a movie image in accordance with a key operation input from the operation portion 18 while displaying a movie image of an object obtained by the camera 21 on the display portion 20. The captured image data are stored in the storage portion 17. The image data stored in the storage portion 17 can be transmitted to a destination of communication by the transmission/reception portion 12. For video communication based on videophone, a movie image of an object is captured by the camera 21 while a voice is input through the microphone 14. These movie image data and voice data are transmitted to a destination of communication by the transmission/reception portion 12. In this event, movie image data and voice data from the destination of communication are received by the transmission/reception portion 12. The received voice is reproduced and output from the receiver 13. The movie image transmitted from the destination of communication or the movie image photographed by the terminal itself is displayed on the display portion 20.

When the display portion 20 of the liquid crystal display unit is driven, a driving voltage has to be applied between electrodes having a liquid crystal layer put therebetween in a display device. In some drive system, some driving frequency, some driving voltage, or the like, noise caused by a driving signal applied to the electrodes may be audible as sounding with an audio frequency. Further, an acrylic panel which is a plate-like insulator is provided in the surface of the liquid crystal display unit so as to be opposed to the display device surface. When this acrylic panel or the like is charged with static electricity or the like, an electrostatic loudspeaker is formed out of the charged acrylic panel and the electrodes of the display device. Due to this electrostatic loudspeaker structure, the noise generated when the liquid crystal display unit is driven is amplified so that the user may feel the sounding conspicuously when the user makes a voice call or the like.

Therefore, according to this embodiment, the driving operation of the display portion 20 including its drive system, driving frequency, driving voltage, etc. is varied in accordance with the operation condition or use condition of the mobile terminal apparatus including a voice call mode, a wait mode, a camera photographing mode, a videophone communication mode, etc., so as to suppress noise generated from the display portion 20. For example, driving operation for suppressing noise of the display portion 20 so as to give priority to the acoustic characteristic is carried out in the voice call mode or the like, so as to secure a good use environment. As the drive system in this case, interlace drive, particularly three-line interlace drive or the like is used. On the other hand, driving operation for giving priority to the image quality of an image displayed on the display portion 20 is carried out in the camera operation mode, so as to improve the visibility. As the drive system in this case, one-line inversion drive or the like is used. Further, driving operation for suppressing the power consumption is carried out in the wait mode. As the drive system in this case, interlace drive, frame inversion drive or the like is used.

Some examples for changing the driving operation of the display portion 20 will be shown in the following embodiments.

### FIRST EMBODIMENT

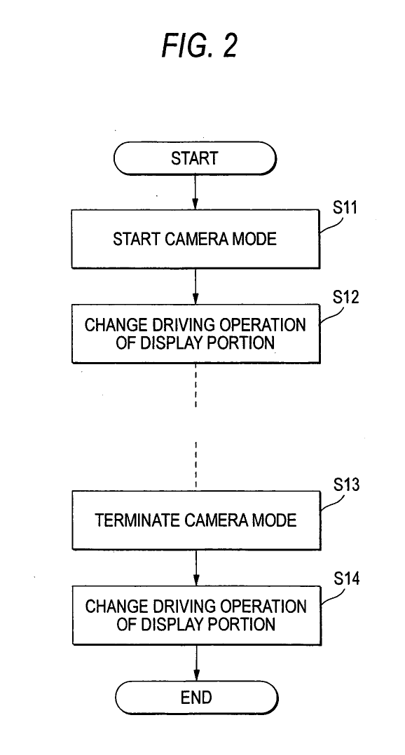

FIG. 2 is a flow chart showing the operation of mobile terminal apparatus according to a first embodiment. In the first embodiment, the driving operation of the display portion 20 is changed at the time of start of a camera mode for operating the camera 21, such as a camera photographing mode, a videophone communication mode, or the like. Thus, driving operation for giving priority to the image quality is performed when an image photographed by the camera 21 is displayed. When the camera mode is terminated, the driving operation of the display portion 20 is changed into driving operation for suppressing noise of the display portion 20.

That is, as soon as the camera mode is started by an operation input of the operation portion 18 or the like from the user (Step S11), the control portion 16 changes the driving operation of the display portion 20 into driving operation for improving the image quality of an image displayed on the display portion 20 (Step S12). Then, as soon as still image or movie photographing, a videophone call or the like using the camera 21 is terminated so that the camera mode is terminated (Step S13), the control portion 16 changes the driving operation of the display portion 20 into driving operation for suppressing noise caused by the display portion 20 (Step S14).

In the cellular phone, the display portion 20 and a voice output portion such as the receiver 13 or the like are located close to each other. In the voice call mode, the user uses the cellular phone with his/her ear close to the display portion 20. Therefore, the user becomes sensitive to noise from the display portion 20. Thus, driving operation for suppressing sounding from the display portion 20 is carried out in a normal mode or the like other than the camera mode, so as to remove the jarring noise and improve the use environment. Specifically, as for the drive system of the display portion 20, interlace drive which is one of interlaced scanning drive systems, preferably three-line interlace drive is used for driving the display portion 20.

On the other hand, when the user's ears are kept away from the display portion 20 in a mode such as the camera mode using the camera, the user does not feel very unpleasant to noise caused by the display portion 20. In this case, on the contrary, the image quality with which an image photographed by the camera 21, an image of an object being photographed likewise, a photographed image sent from a destination of communication, or the like, is displayed on the display portion 20, becomes important. Accordingly, in the camera mode, driving operation for improving the image quality of an image displayed on the display portion 20 is carried out. Particularly in this embodiment, driving operation capable of displaying a high-quality movie on the display portion 20 is carried out in consideration of the case where a movie image being photographed by the camera or a movie image during videophone communication is displayed. Specifically, as for the drive system of the display portion 20, one-line inversion drive which is one of sequential scanning drive systems is used for driving the display portion 20.

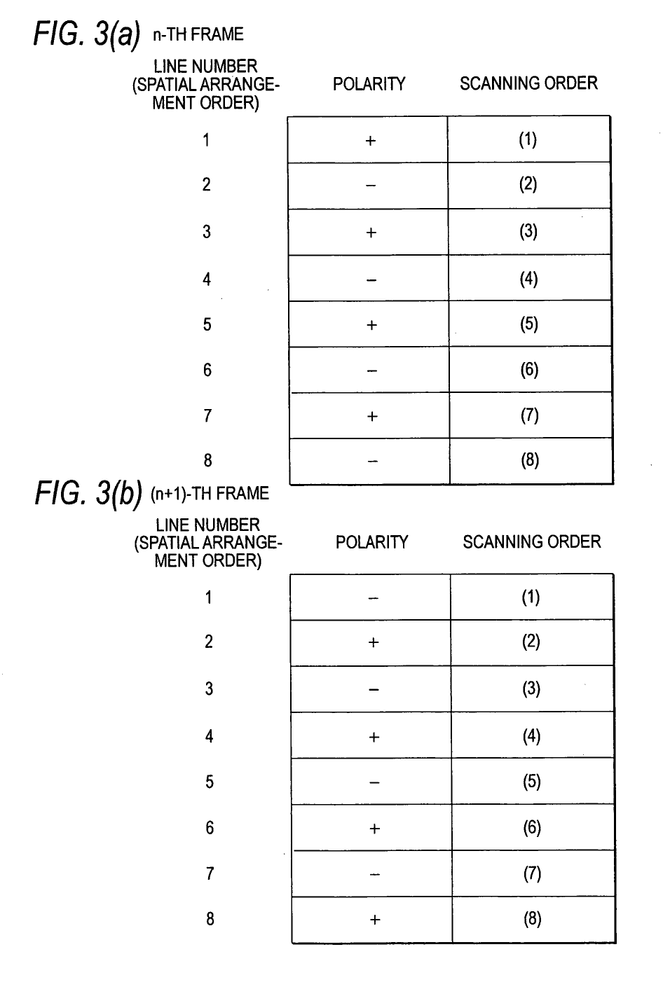

Here, description will be made about the one-line inversion drive and the interlace drive, which are specific examples of drive systems of the liquid crystal display unit. FIG. 3 is an explanatory diagram of the one-line inversion drive. In FIG. 3, the numerals on the left designate the order with which respective lines are spatially arranged in a liquid crystal display device, that is, line numbers. The signs “+” and “−” designate polarities of an applied voltage in each line scanning. The numerals on the right designate the order with which the respective lines should be scanned.

The one-line inversion drive is a drive system in which every line of the liquid crystal display device is scanned sequentially, and the polarity of an applied voltage for driving is inverted for every line. In the n-th frame shown in FIG. 3 (a), the first line located on the top of the display screen is scanned with positive polarity. After that, the polarity is inverted, and the second line is scanned with negative polarity. Then, the polarity is inverted again, and the third line is scanned with positive polarity. In such a manner, scanning is repeated down to the bottom line. After that, in the n+1−th frame shown in FIG. 3 (b), the first line is scanned with negative polarity. After that, the polarity is inverted, and the second line is scanned with positive polarity. Then, the polarity is inverted again, and the third line is scanned with positive polarity. In such a manner, scanning is repeated down to the bottom line. On and after that, this operation will be repeated.

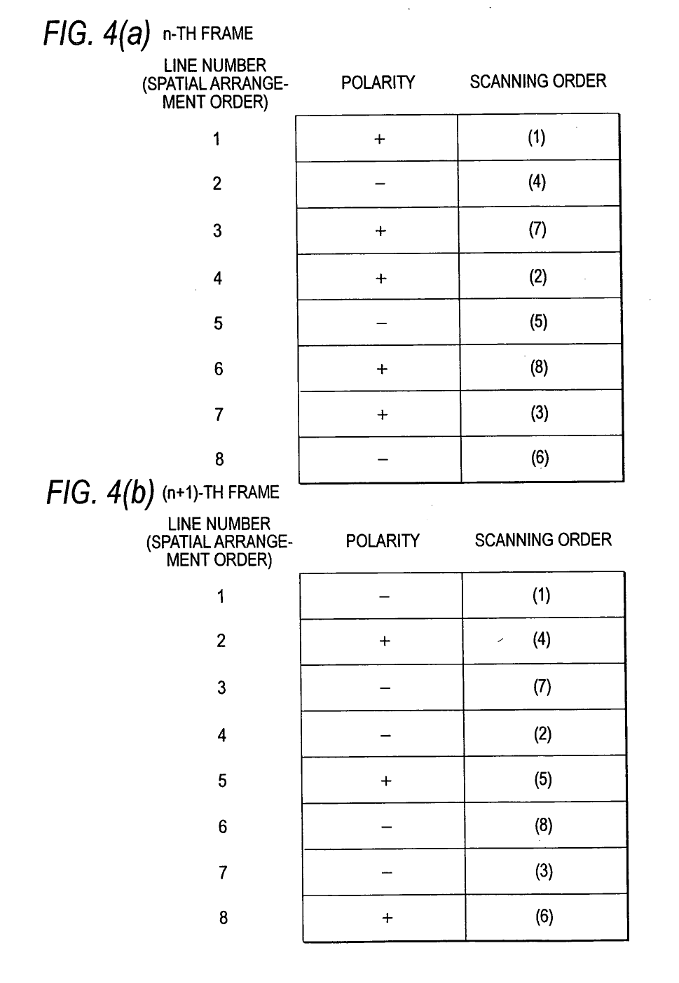

FIG. 4 is an explanatory diagram of three-line interlace drive. In FIG. 4, in the same manner as in FIG. 3, the numerals on the left designate the order with which respective lines are spatially arranged in a liquid crystal display device, that is, line numbers. The signs “+” and “−” designate polarities of an applied voltage in each line scanning. The numerals on the right designate the order with which the respective lines should be scanned.

The interlace drive is also called interlaced scanning drive, which is a drive system for scanning one line for every n lines. In the case of three-line interlace drive, interlaced scanning is performed for every three lines, while the polarity of an applied voltage is inverted whenever the display screen is scanned from its top to its bottom. In the n-th frame shown in FIG. 4 (a), the first line, the fourth line, the seventh line, . . . are scanned with positive polarity. After that, the polarity is inverted, and the second line, the fifth line, the eighth line, . . . are scanned with negative polarity. Then, the polarity is inverted again, the third line, the sixth line, . . . are scanned with positive polarity. After that, in the n+1-th frame shown in FIG. 4 (b), the first line, the fourth line, the seventh line, . . . are scanned with negative polarity. After that, the polarity is inverted, and the second line, the fifth line, the eighth line, . . . are scanned with positive polarity. Then, the polarity is inverted again, the third line, the sixth line, . . . are scanned with negative polarity. On and after that, this operation will be repeated.

Next, description will be made about the relationship between each aforementioned drive system of the liquid crystal display unit and the frequency of sound generated in the display portion.

In the case of the one-line inversion drive, the frequency of sound generated in the display portion depends on the number of lines in the resolution of the display device and the driving frequency (frame frequency here) thereof. That is, frequency of sound=frame frequency×number of lines/2. Accordingly, for example, in the case of a QVGA (240×320 dots) liquid crystal display unit, the frequency of sound is 320×60/2=about 10 kHz, which is recognized as high tone by human ears.

In the case of the n-line interlace drive, the frequency of sound generated in the display portion does not depend on the resolution of the display device, but depends only on the scanning frequency (that is, frame frequency) of the screen. That is, frequency of sound=frame frequency/(2×n). Accordingly, in the case of the three-line interlace drive, the frequency of sound is 60/(2×3)=about 90 Hz. In order to suppress flicker of a displayed image and optimize the image quality, the frame frequency may be increased from 60 Hz to about 100 Hz. In this case, the frequency of generated sound is about 150 Hz, but the frequency is so low that it cannot be recognized easily by human ears.

Therefore, mobile terminal apparatus having no sounding in a display portion can be obtained by this three-line interlace drive. This three-line interlace drive is a drive system in which the frequency of generated sound, if any, is so low that there is no problem about sounding, and the power consumption is low, as compared with the one-line inversion drive. In addition, the three-line interlace drive is a drive system which is not problematic in image quality about crosstalk, flicker, unevenness in the up/down direction of the display screen, etc. in a displayed image, as compared with the frame inversion drive.

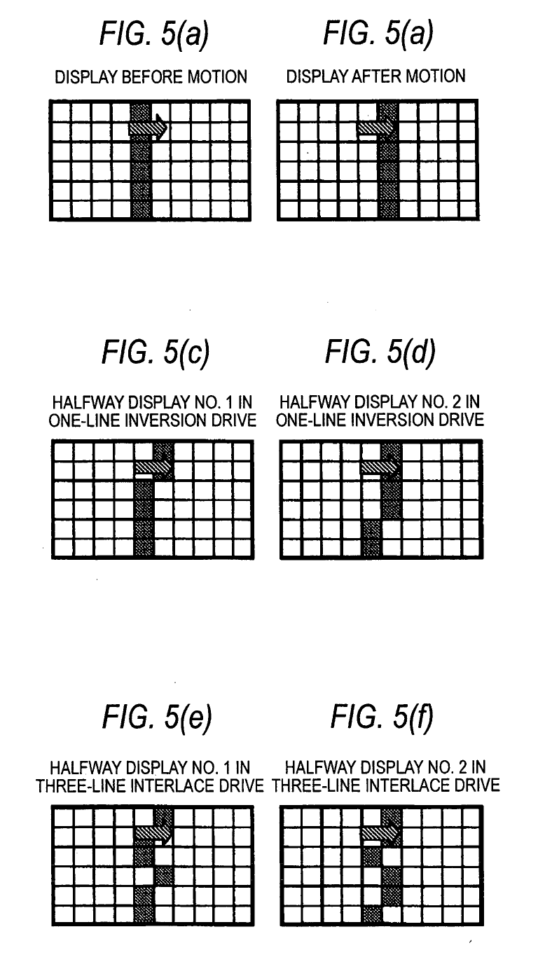

However, according to the interlace drive, there may occur a problem in image quality when a movie is displayed. FIG. 5 is an explanatory view of displayed images when a movie is displayed.

For example, when images of an object in lateral motion are picked up by a camera and displayed as a movie, it is necessary to display an image before the motion in FIG. 5 (a) and an image after the motion in FIG. 5 (b) continuously. Incidentally, FIG. 5 shows an example of display when a linear vertical boundary portion moves right. Here, according to sequential scanning drive such as one-line inversion drive, halfway states as shown in FIGS. 5 (c) and (d) are present between the state before the motion in FIG. 5 (a) and the state after the motion in FIG. 5 (b). In spite of these halfway states, the user hardly has a feeling of wrongness. However, in the case of three-line interlace drive, halfway states as shown in FIGS. 5 (e) and (f) are present between the state before the motion in FIG. 5 (a) and the state after the motion in FIG. 5 (b). Due to irregularities formed thus in the boundary portion, the user has a feeling of wrongness. Incidentally, this feeling of wrongness becomes conspicuous when three of more frames of a movie are displayed at a rate of five or more frames per second. Accordingly, there occurs no special feeling of wrongness when the screen is switched at a rate not higher than five frames per second.

Therefore, interlace drive is not very suitable for displaying a movie. In order to improve the image quality when a movie is displayed, it is necessary to increase the frame frequency which is one of driving conditions in the case of interlace drive. Alternatively, the drive system may be changed to use sequential scanning drive such as one-line inversion drive or the like.

According to the first embodiment, in consideration of the characteristic of sound generated in the display portion as described previously and the characteristic of the image quality when a movie is displayed, the driving operation of the display portion is changed into the one-line inversion drive as soon as the camera mode is started. Thus, the image quality is improved when a movie is displayed. As soon as the camera mode is terminated, the driving operation of the display portion is changed into the three-line interlace drive so as to eliminate sounding caused by the display portion. In this manner, a drive system giving priority to the image quality is used when a movie is displayed in the camera mode. Thus, a high-quality displayed image can be obtained so that the visibility can be improved. On the other hand, in another operation mode such as a voice call mode or the like, a drive system giving priority to the acoustic characteristic is used. Thus, sounding caused by the display portion can be prevented so that the use environment can be improved.

Incidentally, an example in which the one-line inversion drive giving priority to the image quality for displaying a movie image is used in the camera mode has been described in the aforementioned first embodiment. However, the one-line inversion drive may be also applied to another movie display mode so as to obtain a similar effect. For example, it may be applied to a movie file playback mode, a movie/animation playback mode, a game operation mode, etc.

### SECOND EMBODIMENT

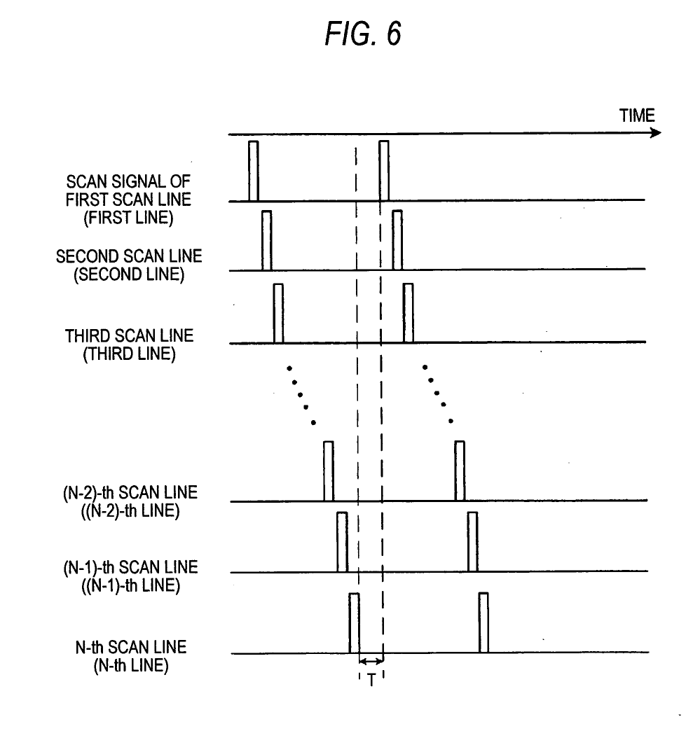

FIG. 6 is a timing chart for explaining the operation of mobile terminal apparatus according to a second embodiment. This FIG. 6 shows the condition of line scanning in a display portion and the timing of changing the driving operation thereof.

The second embodiment shows an example of timing of changing the driving operation of the display portion 20 in the liquid crystal display unit. When the driving operation is changed in the middle of displaying an image on the display portion 20, there is a fear that the display screen is disordered for a moment, or an image different from a normal one is displayed. Therefore, in order to prevent such a failure in a displayed image when the drive is changed, the drive is changed in a period when the screen of the liquid crystal display device is not actually scanned.

Specifically, as shown in FIG. 6, after scanning all the lines from the first line to the N-th line, the driving operation of the drive system, the driving frequency, the driving voltage, etc. is changed in a blanking period T before starting to scan the first line of the next frame. Incidentally, when the time required for changing the drive cannot be secured satisfactorily with respect to the timing of line scanning, the scanning may be temporarily suspended after all the lines are scanned, in order to change the drive in this suspension period.

Here, two examples will be described below as examples of operations for changing the drive. The first example shows the case where changing the drive is controlled in the display portion controller 19 on the liquid crystal display unit side. In this case, when the display portion controller 19 receives, from the control portion 16, a control signal for giving an instruction to change the drive, the display portion controller 19 changes the driving operation of the display portion 20 after all the lines are once scanned even if one line is being scanned. That is, when the display portion controller 19 receives a control signal for changing the drive in the middle of line scanning, the display portion controller 19 waits till all the lines are completely scanned, and changes the driving operation in the blanking period T before starting to scan the first line of the next frame. Alternatively, the display portion controller 19 temporarily suspends scanning after scanning all the lines, and resumes scanning the next frame after changing the driving operation.

The second example shows the case where changing the drive is controlled in the control portion 16. In this case, the control portion 16 refers to a sync signal such as Vsync or the like for timing with scanning in the display portion 20, and sends the display portion controller 19 a control signal in timing with this sync signal so as to make the display portion controller 19 change the drive operation at timing after all the lines are scanned. Alternatively, after all the lines are scanned, the control portion 16 suspends the sync signal or the like so as to temporarily suspend scanning, and then sends a control signal for changing the drive so as to change the driving operation. After that, the control portion 16 resumes scanning the next frame. In this event, the sync signal may be supplied from the control portion 16 side to the display portion controller 19, or may be output from the display portion controller 19 on the liquid crystal display unit side.

In such a manner, according to the second embodiment, the driving operation is changed in a period after scanning of one frame is terminated and before scanning the next frame is started. Thus, it is possible to prevent a problem in display, such as disorder of a displayed image or the like. Accordingly, it is possible to prevent occurrence of any change in a displayed image when the driving operation of the drive system, the driving frequency, the driving voltage, etc. is changed. Thus, the change of the driving operation can be made so unostentatious that the user cannot be aware of it.

### THIRD EMBODIMENT

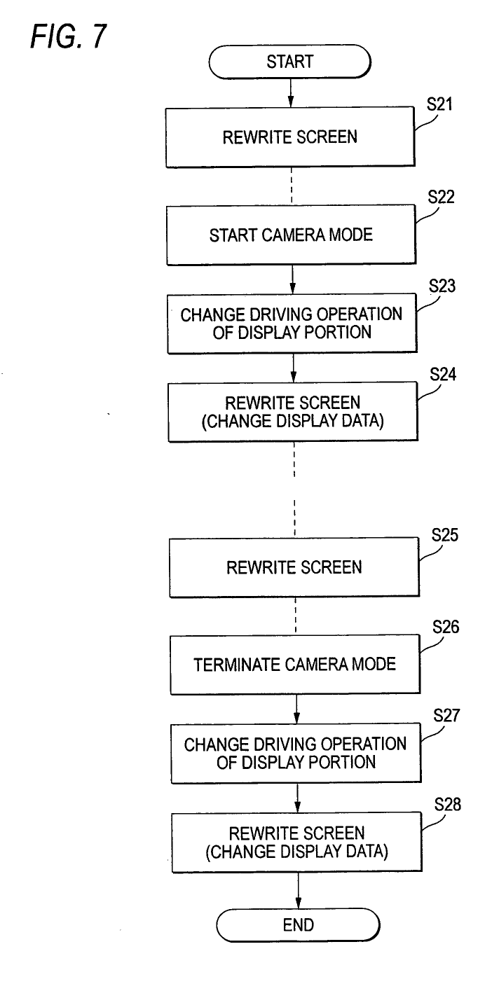

FIG. 7 is a flow chart showing the operation of mobile terminal apparatus according to a third embodiment. The third embodiment shows another example for making the change of the driving operation so unostentatious that the user cannot be aware of it. This third embodiment may be used when the aforementioned drive change control according to the second embodiment cannot be used or when it takes several milliseconds or longer time to change the drive.

In the third embodiment, the contents of display are changed by rewriting the screen when the driving operation of the display portion 20 is changed. That is, the screen is rewritten as to the contents of display in the display portion 20 (Step S21). After that, as soon as the camera mode is started (Step S22), the control portion 16 changes the driving operation of the display portion 20 into the driving operation in which the image quality of an image displayed on the display portion 20 is improved (Step S23). Then, immediately after the driving operation of the display portion 20 is changed, display data are sent to the display portion 20 so that the screen is rewritten (Step S24). In this event, the display data are changed to be different from those when the screen is rewritten in the previous Step S21, and the changed display data are sent so that different images are displayed before and after the drive change. Incidentally, the screen maybe rewritten to different display contents either immediately after or immediately before the driving operation is changed. Particularly, however, the screen had better be rewritten immediately after the change.

Then, the screen is rewritten as to the display contents of the display portion 20 in the camera mode (Step S25). After that, as soon as the camera mode is terminated (Step S26), the control portion 16 changes the driving operation of the display portion 20 into the driving operation in which noise caused by the display portion 20 is suppressed (Step S27). Then, immediately after the driving operation of the display portion 20 is changed, display data are sent to the display portion 20 so as to rewrite the screen (Step S28). Likewise in this event, display data different from those when the screen is rewritten in the previous Step S25 is sent so that different images are displayed before and after the drive change.

For example, in the case of a liquid crystal display unit, a driving voltage is applied at intervals of about 16 ms when the liquid crystal display unit is normally driven. Accordingly, a displayed image can be held even if the driving voltage is not applied for a period of about 20 ms. However, the image will be gradually brighter or darker without scanning. Accordingly, when substantially similar images are displayed before and after the drive change though it takes much time for the drive change, abnormality such as disorder of a displayed image at the time of the drive change is recognized by the user. Therefore, in the third embodiment, the screen is rewritten to display different displayed images on the display portion before and after the drive change when the driving operation is changed.

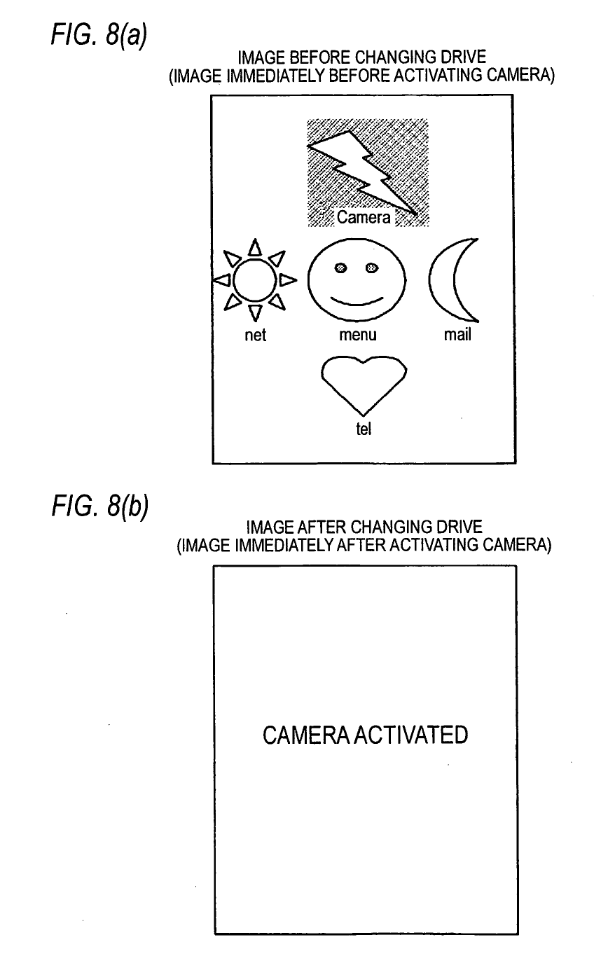

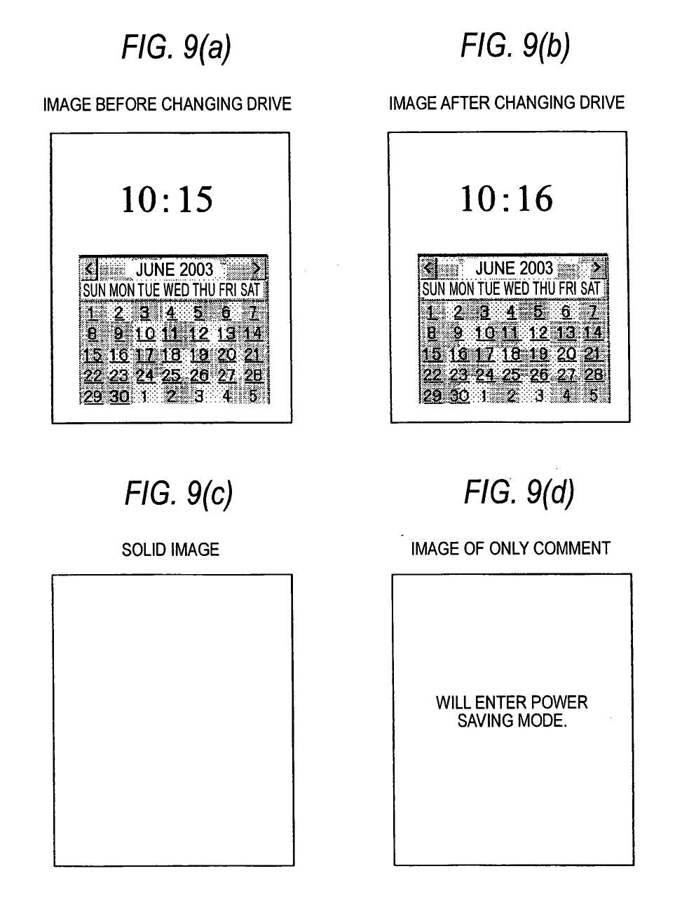

FIGS. 8 and 9 are views showing examples of switching displayed images at the time of changing the drive of the display portion. The first example shown in FIG. 8 shows an example of display when the camera is activated. A menu image is displayed before the drive change (immediately before the camera is activated) as shown in FIG. 8 (a), while a character image of “camera activated” or the like is displayed after the drive change (immediately after the camera is activated) as shown in FIG. 8 (b).

The second example shown in FIG. 9 shows an example of display when similar images are to be displayed before and after drive change. In this case, an image before the drive change as shown in FIG. 9 (a) and an image after the drive change as shown in FIG. 9 (b) are quite the same as or substantially similar to each other. When those images are displayed, the image after the drive change is displayed after another different image is once displayed. For example, assume that the drive is changed when the image before the drive change in FIG. 9 (a) is being displayed. In this case, it is preferable that a solid image in one and the same color as shown in FIG. 9(c) or an image close thereto, or a character image having only a comment as shown in FIG. 9(d) is displayed, and the image after the drive change in FIG. 9(b) is then displayed.

In such a manner, according to the third embodiment, when the driving operation is changed, a displayed image is rewritten so that different images are displayed before and after the drive change. Accordingly, the change of the displayed image at the time of the drive change can be made so unostentatious that the user cannot be aware of the change of the driving operation.

### FOURTH EMBODIMENT

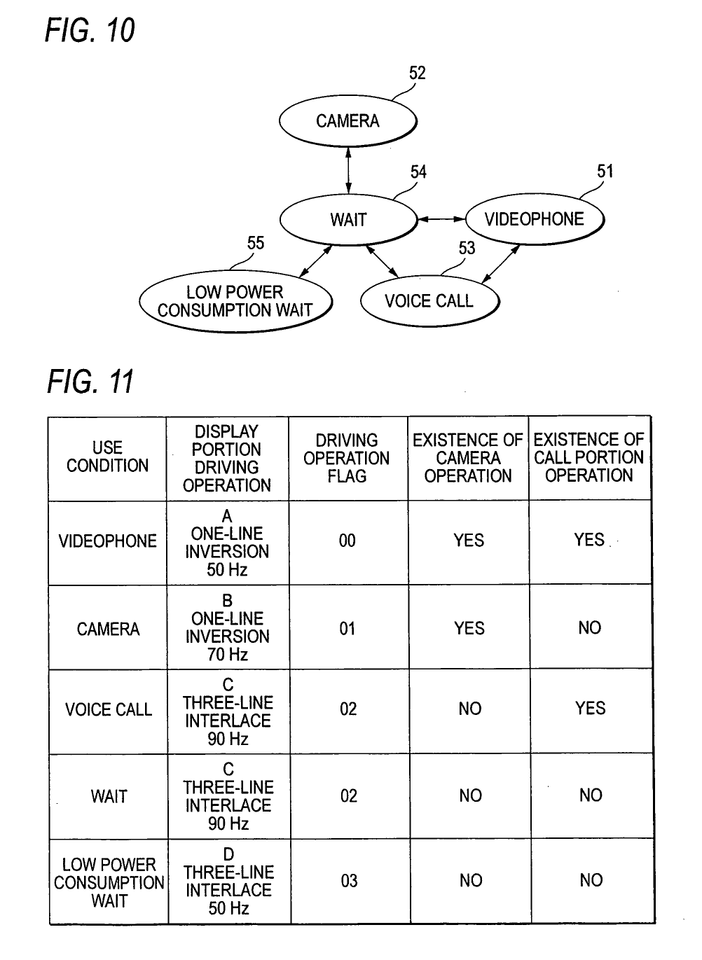

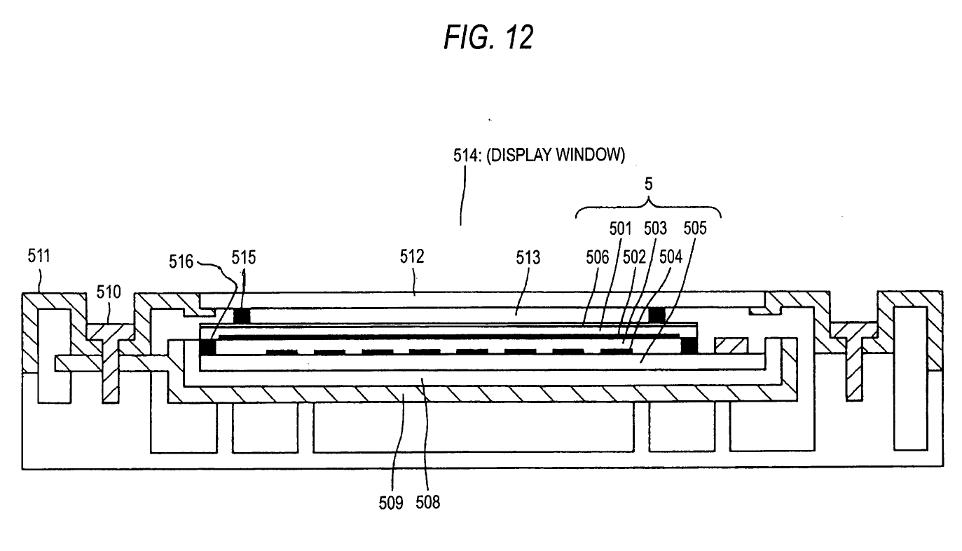

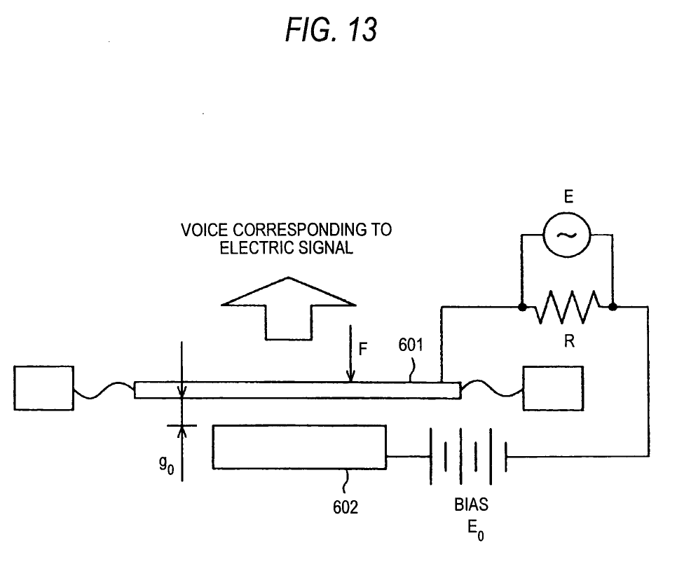

FIG. 10 is a diagram showing operation modes of the mobile terminal apparatus according to this embodiment. FIG. 11 is a diagram showing the correspondence of the contents of driving operation of a display portion to the operating condition of each part in each operation mode in the fourth embodiment.

In the aforementioned first to third embodiments, description was made about the change of the driving operation of the display portion paying attention to prevention of sounding caused by the display portion or improvement of the image quality at the time of displaying a movie. However, the present invention can be also applied to another operation mode so as to change the drive system, the driving frequency, the driving voltage, etc. into suitable states. When the driving operation of the display portion is changed adaptively in accordance with the use purpose or use condition of mobile terminal apparatus, mobile terminal apparatus optimized in each operation mode as to the image quality, the sounding, the power consumption, etc. in the display portion can be provided without using any detection means or without user's special operation.

For example, in a liquid crystal display unit, when the driving frequency is higher to some extent, the image quality is improved with less flicker or the like. However, the power consumption is increased. Accordingly, the driving frequency is increased to a high frequency in accordance with the operation condition of the mobile terminal apparatus when the user is carrying out some operation or when a movie is being displayed. In the wait mode, the driving frequency is lowered. In such a manner, the driving conditions are changed.

Here, specific examples of changing settings of the driving operation of the display portion will be described below. The mobile terminal apparatus according to this embodiment as shown in FIG. 1 have a plurality of operation modes such as a videophone mode 51, a camera mode 52, a voice call mode 53, a wait mode 54, a low power consumption wait mode 55, etc. as shown in FIG. 10. In these operation modes 51 to 55, different driving operations are applied to have driving conditions suitable for the operation modes respectively as shown in FIG. 11. Thus, the driving operation of the display portion 20 is changed over.

In the videophone mode 51, the display portion 20 is driven with a drive operation A using one-line inversion drive as a drive system and at a frame frequency of 50 Hz. In the camera mode 52, the display portion 20 is driven with a driving operation B using one-line inversion drive and at a frame frequency of 70 Hz higher than that in the driving operation A. In the voice call mode 53 and the wait mode 54, the display portion 20 is driven with a driving operation C using three-line interlace drive as a drive system and at a frame frequency of 90 Hz. In the low power consumption wait mode 55, the display portion 20 is driven with a driving operation D using three-line interlace drive as a drive system and at a frame frequency of 90 Hz lower than that in the driving operation C.

Next, four examples will be described below as examples of operations for changing the drive. Here will be shown examples in which at least two programs are operated in the control portion 16 so that changing the drive is controlled by one of the programs. One of the programs is a display control program for controlling the driving of the display portion 20. The other program is a program for controlling each function or each device including a camera function, a video phone function, etc. other than the function of controlling the driving of the display portion 20, or for controlling the apparatus as a whole (hereinafter referred to as an apparatus control program collectively).

The first example shows the case where drive change is controlled directly by an apparatus control portion operating based on the apparatus control program. In this case, whenever the operation mode of the mobile terminal apparatus is changed over into another operation mode by the apparatus control portion, a control command is sent from the apparatus control portion directly to the display portion controller 19 in accordance with each operation condition, or a control command is sent to a display control portion operating based on the display control program. Thus, the driving operation of a display portion 40 is changed. For example, to shift from the wait mode 54 to the camera mode 52, a corresponding control command is sent to change the driving operation of the display portion 20 from the driving operation C to the driving operation B.

The second example shows the case where a flag memory for storing a driving operation flag indicating the kind of driving operation of the display portion in accordance with the operating condition is provided in the storage portion 17 or the like, so as to control the drive change in accordance with the contents of this driving operation flag. For example, assume that the driving operation flag corresponding to the driving operation A is “00”, the driving operation flag corresponding to the driving operation B is “01”, the driving operation flag corresponding to the driving operation C is “02”, and the driving operation flag corresponding to the driving operation D is “03”. In this case, when the operation mode of the mobile terminal apparatus is changed over by the apparatus control portion, the driving operation flag in the flag memory is rewritten in accordance with the operating condition of the apparatus. Then, the flag memory is referred to by the display control portion, and a control command is sent to the display portion controller 19 in accordance with the contents of the driving operation flag so as to change the driving operation of the display portion 40.

In this second example, the drive change can be controlled by one flag memory so that the memory capacity to be used as the flag memory can be saved. For example, to shift from the wait mode 54 to the videophone mode 51, the driving operation flag is rewritten from “02” to “00” by the apparatus control portion. Next, when some signal is sent to the display portion controller 19 by the display control portion (for example, when data for updating the display are sent), the driving operation of the display portion 20 is changed from the driving operation C to the driving operation A in accordance with the contents of the driving operation flag.

The third example shows the case where the existence of the operation of hardware corresponding to each operation condition is detected, and changing the drive is controlled based on a result of this detection. In this case, the display control portion monitors hardware ports to which respective pieces of hardware such as the camera 21, the call portion 11, etc. are connected, so that the display control portion detects the operating condition of the hardware and recognizes the operation mode. Then, a control command is sent to the display portion controller 19 in accordance with the current operation mode so as to change the driving operation of the display portion 40. For example, when the camera 21 is operating but the call portion 11 is not operating, the display control portion recognizes the current operation mode as the camera mode 52 in which only the camera is in use. Thus, the display control portion sets the driving operation of the display portion 20 as the driving operation B. In this third example, changing the drive can be controlled without using any memory.

The fourth example shows the case where a plurality of flag memories for storing driving operation flags indicating the driving conditions of pieces of hardware are provided in the storage portion 17 or the like, so as to control the drive change in accordance with the contents of these driving operation flags. Here, for example, assume that each driving operation flag is “1” when its corresponding hardware is in operation, and “0” when the hardware is not in operation. In this case, when the operation mode of the mobile terminal apparatus is changed over by the apparatus control portion, each of the driving operation flags in the flag memories is rewritten whenever the operation of its corresponding piece of hardware is turned on/off. Then, the flag memories are referred to by the display control portion, and the operation conditions of the hardware are recognized in accordance with the contents of the operation condition flags in the flag memories. A control command is sent to the display portion controller 19 in accordance with a current operation mode so as to change the driving operation of the display portion 40. In this fourth example, it will go well only if the flag memories are read. Thus, high-speed processing can be performed as compared with that in the case where the operation of each piece of hardware is detected directly.

Incidentally, in the wait mode 54 or the low power consumption wait mode 55, frame inversion drive may be used as the driving operation of the display portion 40. The frame inversion drive is inferior in image quality to the one-line inversion drive, the three-line interlace drive or the like when a still picture is displayed, because unevenness in the up/down direction of the display screen, crosstalk, flicker, etc. are apt to be ostentatious according to the frame inversion drive. However, the frame inversion drive is advantageous in low power consumption because the driving frequency is the lowest. Accordingly, for the purpose of use in which low power consumption is desired, for example, when the apparatus is in a wait state where the apparatus is standby because there has been no key operation input for a predetermined time, or when a movie or an animation having images to be displayed for a long time is reproduced, the frame inversion drive can be used to save the power consumption of the display portion 40.

Examples in which a liquid crystal display unit is used as the display portion 20 have been described in the aforementioned embodiments. However, the present invention is not limited to such examples. A similar sounding phenomenon to that of a liquid crystal display unit occurs in a display unit which has a planar electrode and is driven by applying a voltage to this electrode, and in which the driving voltage fluctuates periodically and a planar nonconductor such as an acrylic panel or the like is opposed to the electrode. In addition, problems occurring when the driving operation is changed can be considered similarly. Accordingly, similar effect can be obtained even when the present invention is applied to another display unit such as an EL display unit or the like.

As described above, according to these embodiments, the driving operation giving priority to the acoustic characteristic is carried out when a call function or a voice playback function is used in a voice call mode or the like. Thus, influence of noise generated by the display portion 20 can be prevented. On the other hand, the driving operation giving priority to the image quality of a displayed image is carried out in a movie display mode such as a camera photographing mode, a videophone communication mode, or the like. Thus, a movie image giving no feeling of wrongness to the user can be displayed so that the visibility is improved. Accordingly, it is possible to provide mobile terminal apparatus in which acoustic characteristic, displayed image quality and power consumption characteristic suitable for use conditions or use purpose of each driving operation can be obtained by changing the driving operation including driving conditions of a display device such as the drive system, the driving frequency, the driving voltage, etc. in accordance with the use conditions or the use purpose. In addition, it is possible to provide mobile terminal apparatus which is eco-friendly because the power consumption can be reduced in accordance with an operation mode.

Although the present invention has been described in details and with reference to its specific embodiments, it is obvious for those skilled in the art that various charges or modifications can be made on the present invention without departing from its spirit and scope.

This application is based on a Japanese patent application (Japanese Patent Application No. 2003-375464) filed on Nov. 11, 2003, whose contents are incorporated herein as reference.

### INDUSTRIAL APPLICABILITY

The present invention has an effect that occurrence of noise can be suppressed while keeping required display capacity in accordance with the operation condition of apparatus. The present invention is applicable to mobile terminal apparatus or the like having a display unit such as a liquid crystal display unit or the like.

1. A mobile terminal apparatus comprising:
a display portion to be driven by a voltage applied thereto; and
a display portion driving control unit which changes driving operation of the display portion including at least one of a drive system and a driving frequency thereof, so as to make driving condition of the display portion adapted to operation condition of the apparatus itself.

2. The mobile terminal apparatus according to claim 1,
wherein the display portion driving control unit changes the drive system so as to drive the display portion by sequential scanning drive when movie display is performed, and to drive the display portion by interlaced scanning drive when another display is performed.

3. The mobile terminal apparatus according to claim 1,
wherein the display portion driving control unit changes the drive system so as to drive the display portion by sequential scanning drive in a camera mode for operating a camera, and to drive the display portion by interlaced scanning drive in another operation mode.

4. The mobile terminal apparatus according to claim 3,
wherein the display portion driving control unit changes the drive system of the display portion into the sequential scanning drive as soon as the camera mode is started, and changes the drive system of the display portion into the interlaced scanning drive as soon as the camera mode is terminated and shifted to another operation mode.

5. The mobile terminal apparatus according to claim 1,
wherein when the display portion driving control unit changes the driving operation, the display portion driving control unit carries out the driving operation change in a period after scanning one screen in the display portion is completed and before scanning a next screen is started.

6. The mobile terminal apparatus according to claim 1,
wherein when the display portion driving control unit changes the driving operation, the display portion driving control unit changes display contents of the display portion in the vicinity of changing the driving operation.

7. The mobile terminal apparatus according to claim 1,
wherein the display portion driving control unit changes at least one of the drive system, the driving frequency and the driving voltage of the display portion in accordance with the operation condition of the apparatus itself.

8. The mobile terminal apparatus according to claim 1,
wherein the display portion driving control unit changes the drive system of the display portion into interlaced scanning drive or frame inversion drive when the apparatus itself is in a standby state.
